(19) United States
(12) Patent Application Publication
(10) Pub. No.: US 2026/0133361 A1
(43) Pub. Date: May 14, 2026

(54) MULTI-LAYER HOLLOW-CORE ANTI-RESONANT OPTICAL FIBER

(71) Applicant: Lumentum Operations LLC, San Jose, CA (US)

(72) Inventor: Filip SUHADOLC, Grosuplje (SI)

(21) Appl. No.: 19/262,603

(22) Filed: Jul. 8, 2025

Related U.S. Application Data
(60) Provisional application No. 63/719,539, filed on Nov. 12, 2024.
(60) Provisional application No. 63/748,808, filed on Jan. 23, 2025.

(51) Int. Cl. G02B 6/02

(52) U.S. Cl. CPC G02B 6/02361; G02B 6/02328

(57) ABSTRACT

An anti-resonant hollow-core optical fiber includes an outer cladding; a holding tube; a first plurality of cladding elements arranged within the outer cladding; and a second plurality of cladding elements arranged in contact with an inner wall of the holding tube, such that the second plurality of cladding elements define a hollow core, wherein a first wall thickness of the second plurality of cladding elements causes a first anti-resonant condition for the hollow core and a sum of a holding tube wall thickness and a wall thickness of first plurality of cladding elements causes a second anti-resonant condition for the hollow core.

### CROSS-REFERENCE TO RELATED APPLICATION

This patent application claims priority to U.S. Provisional Patent Application No. 63/719,539, filed on Nov. 12, 2024, and entitled “HOLLOW-CORE ANTI-RESONANT FIBER” and to U.S. Provisional Patent Application No. 63/748,808, filed on Jan. 23, 2025, and entitled “HOLLOW-CORE ANTI-RESONANT FIBER.” The disclosures of the prior applications are considered part of and are incorporated by reference into this patent application.

### TECHNICAL FIELD

The present disclosure relates generally to optical fibers and to multi-layer hollow-core anti-resonant optical fibers.

### BACKGROUND

A hollow-core fiber (HCF) is a type of optical fiber designed to guide light traveling through an air-filled, gas-filled, or vacuum core rather than through a solid glass core, which is used in some optical fibers. Unlike optical fibers that have a solid glass core, HCFs have a central hollow core, usually surrounded by a microstructured cladding. HCFs can be split into different types based on a guidance mechanism. One type of HCF includes photonic bandgap fibers, confine light by surrounding the hollow core with a periodic lattice of nodes. Another type of HCF (e.g., an anti-resonant hollow-core fiber (AR-HCF)) includes anti-resonant fibers, which surround the core with a cladding of slender glass membranes of a specific thickness that are in anti-resonance with a core-guided light. The microstructured cladding of the AR-HCF may be made up of thin glass tubes or membranes arranged in a way that prevents light from escaping the hollow core through a mechanism called anti-resonance. The design of the microstructured cladding is such that the microstructured cladding creates an anti-resonant effect for certain wavelengths of light, effectively reflecting the light back into the hollow core. Thus, the anti-resonant effect minimizes light leakage and enhances transmission efficiency. AR-HCFs can support a wide range of wavelengths, making AR-HCFs suitable for various applications, including telecommunications, sensing, and high-power laser delivery.

### SUMMARY

In some implementations, an anti-resonant hollow-core optical fiber includes an outer cladding; a holding tube; a first plurality of cladding elements arranged within the outer cladding; and a second plurality of cladding elements arranged in contact with an inner wall of the holding tube, such that the second plurality of cladding elements define a hollow core, wherein a first wall thickness of the second plurality of cladding elements causes a first anti-resonant condition for the hollow core and a sum of a holding tube wall thickness and a wall thickness of first plurality of cladding elements causes a second anti-resonant condition for the hollow core.

In some implementations, an anti-resonant hollow-core optical fiber includes an exterior cladding; a first layer disposed within the exterior cladding and defining a first inner volume, wherein the first layer includes a first set of cladding elements; a second layer disposed within the first layer and defining a second inner volume, wherein the second layer includes a second set of cladding elements, wherein the second set of cladding elements defines a hollow core; and a holding tube disposed between the first layer and the second layer, wherein a configuration of the first set of cladding elements, the second set of cladding elements, and the holding tube is associated with reducing a loss of a fundamental mode associated with the hollow core.

In some implementations, a layered hollow-core optical fiber includes a first plurality of cladding elements disposed in a first interior volume; a second plurality of cladding elements disposed in a second interior volume; and a holding tube disposed between the first interior volume and the second interior volume, wherein the second plurality of cladding elements define a hollow core, and wherein respective wall thicknesses of the first plurality of cladding elements, the second plurality of cladding elements, and the holding tube are configured to cause an anti-resonant condition for the hollow core.

### BRIEF DESCRIPTION OF THE DRAWINGS

FIG. 1 is a diagram of an example optical fiber, such as a multi-layer hollow-core anti-resonant optical fiber.

FIG. 2 is a diagram associated with an example optical fiber, such as a set of components associated with a multi-layer hollow-core anti-resonant optical fiber.

FIGS. 3A and 3B are diagrams of formation of a hollow core, such as for a hollow-core anti-resonant optical fiber.

FIG. 4 is a flowchart of an example process associated with manufacturing a multi-layer hollow-core anti-resonant optical fiber.

### DETAILED DESCRIPTION

The following detailed description of example implementations refers to the accompanying drawings. The same reference numbers in different drawings may identify the same or similar elements.

A hollow-core anti-resonant fiber, which may be referred to as an “HC-ARF” or an “AR-HCF,” can be used to propagate light through a core (e.g., an air-filled core, a gas-filled core, or a vacuum core, among other examples) surrounded by a microstructured cladding. For example, an HC-ARF may include a set of cladding elements that are arranged in a ring formation around a hollow core, through which light can be propagated. The set of cladding elements, which may also be referred to as “capillaries,” “walls,” or “capillary walls,” confines the light in the hollow core using anti-resonant reflection. Use of an HC-ARF may provide lower loss, may reduce non-linear effects, and may achieve higher power capacity than other types of optical fibers. Accordingly, HC-ARFs may be used in telecommunications to support low-latency data transmission and high-capacity networks. Additionally, or alternatively, HC-ARFs can be used in high-power laser systems, such as for industrial laser processing (e.g., cutting or welding) or medical applications (e.g., laser surgery or dermatological procedures), by providing for the precise and efficient delivery of high-powered laser beams with minimal loss or beam distortion.

Furthermore, HC-ARFs may support ultrafast pulse transmission, such as for femtosecond and picosecond laser pulses with minimal dispersion, thereby enabling use cases, such as spectroscopy, imaging, or generation of a supercontinuum spectrum, among other examples. In some sensing applications, rather than an air-filled hollow core, an HC-ARF may have a gas-filled core that allows for extended interaction lengths, which may improve a sensitivity of a sensor. Other HC-ARFs may have a vacuum filled core that may result in other characteristics. Some HC-ARFs may support non-linear optical processes, such as Raman scattering or four-wave mixing, among other examples, thereby providing for improved light sources or detection capabilities in some applications, such as environmental monitoring.

Optimization techniques can be used to configure an arrangement and size of the cladding elements that surround the hollow core of an HC-ARF, thereby enabling configuration of a particular set of properties for an HC-ARF. However, HC-ARFs may be subject to fundamental mode (FM) loss. For example, HC-ARFs may experience excessive leakage at areas between the cladding elements that define the hollow core of the HC-ARF when individual cladding elements are separated by too large a gap. Similarly, HC-ARFs may experience losses when junctions are formed where light can exist when individual cladding elements are not separated by a sufficient gap.

Some implementations described herein provide a multi-layer HC-ARF. For example, an HC-ARF may include a set of outer cladding elements in a first ring formation and a set of inner cladding elements in a second formation offset from the first ring formation. In this case, a configuration of the cladding elements, such as locations of the cladding elements and wall thicknesses of the cladding elements (and a holding tube wall thickness of a holding tube), may reduce FM loss by the HC-ARF. In some implementations, the HC-ARF may include a holding tube that provides support to the inner cladding elements, or an outer cladding layer that surrounds the outer cladding elements. In this way, by providing multiple layers of cladding elements, a sum of a wall thickness of the outer cladding elements and a holding tube wall thickness of the holding tube result in a reflection of light that is escaping from the hollow core defined by the inner cladding elements (and escaping through gaps between the inner cladding elements), thereby reducing FM loss. For example, the HC-ARF may achieve a confinement loss of the fundamental mode is less than 1 decibel (dB) per kilometer (km).

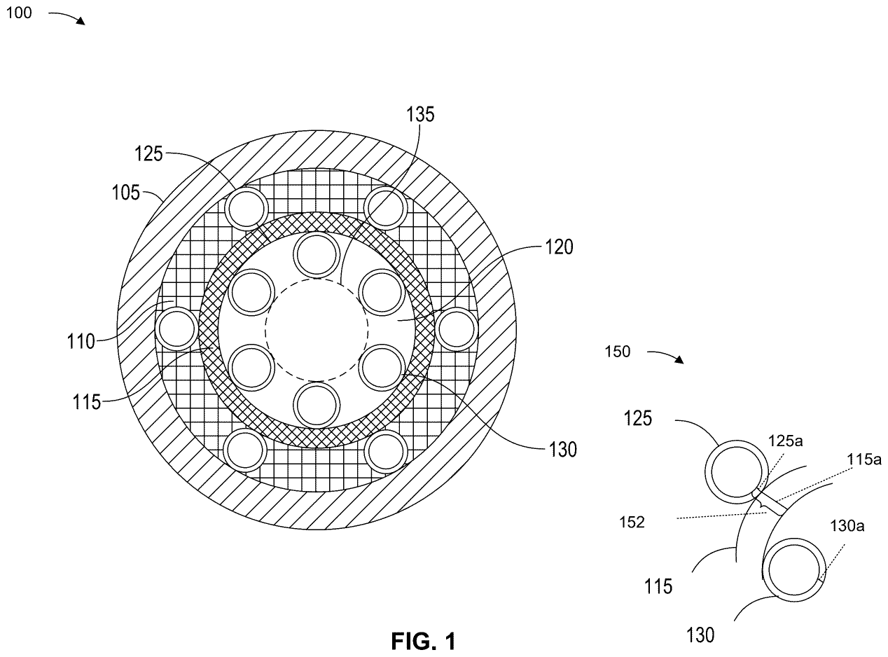

FIG. 1 is a diagram of an example optical fiber 100, such as a multi-layer hollow-core anti-resonant optical fiber. The optical fiber 100 may include an exterior cladding 105, an outer cladding layer 110, a holding tube 115, and an inner cladding layer 120. A first set of cladding elements 125 may be disposed in a first interior volume corresponding to the outer cladding layer 110. A second set of cladding elements 130 may be disposed in a second interior volume corresponding to the inner cladding layer 120. The second set of cladding elements 130 may define a hollow core region 135 that may convey a beam or optical signal.

In some implementations, the outer cladding layer 110 may have an outer wall and an inner wall that define a first interior volume in which the first set of cladding elements 125 are disposed. For example, the first set of cladding elements 125 may be disposed between the first inner wall of the outer cladding layer 110 and the first outer wall of the outer cladding layer 110. In some implementations, the outer cladding layer 110 may be a hollow layer. For example, the exterior cladding 105 may form an outer boundary or wall and the holding tube 115 may form an inner boundary or wall that define a space of the outer cladding layer 110 in which the first set of cladding elements 125 is disposed. In this case, the hollow layer of outer cladding layer 110 may be a vacuum medium or may include a gaseous medium, such as air, or a liquid medium.

Alternatively, the outer cladding layer 110 may be a material layer. In some implementations, the outer cladding layer 110 is associated with a particular fill material. For example, the outer cladding layer 110 may have a material, such as doped silica glass, that is disposed between the first set of cladding elements 125. Although some implementations are described herein in terms of a particular set of material types or phases, other material types or phases are contemplated. Additionally, although some layers are described herein in terms of a single material or a single monolithic layer, it is contemplated that individual layers described herein may comprise multiple materials or multiple layers. It is contemplated that different material or structural configurations may have different manufacturing processes.

In some implementations, the exterior cladding 105 and the outer cladding layer 110 may be formed from a single type of material. For example, exterior cladding 105 and a material of outer cladding layer 110 disposed between the first set of cladding elements 125 may be the same material. In this case, rather than a wall being formed between the outer cladding layer 110 and the exterior cladding 105, the outer cladding layer 110 and the exterior cladding 105 may be a single continuous layer into which the first set of cladding elements 125 is disposed (e.g., via drilling).

Alternatively, the exterior cladding 105 may be a distinct layer that is in contact with the outer wall of the outer cladding layer 110. For example, the exterior cladding 105 may be a first material, the outer cladding layer 110 may be a second material, and the holding tube 115 may be a third material. In this case, the first set of cladding elements 125 is disposed within the second material. Alternatively, the outer cladding layer 110 and the holding tube 115 may be a same material. In this case, rather than a wall being formed between the outer cladding layer 110 and the holding tube 115, the outer cladding layer 110 and the holding tube 115 may be a single continuous layer into which the first set of cladding elements 125 is disposed (e.g., via drilling).

In some implementations, the holding tube 115 may include an outer wall and an inner wall. For example, the inner wall of the holding tube 115 may form a structure that supports the second set of cladding elements 130 within the second interior volume corresponding to the inner cladding layer 120. In this case, the second set of cladding elements 130 may be in contact with the inner wall of the holding tube 115. In some implementations, the holding tube 115 may have a holding tube wall thickness that, together with other wall thicknesses (e.g., together with the wall thickness of the cladding elements 125), is associated with an anti-resonant condition. For example, a holding tube wall thickness of the holding tube 115 may be configured such that, together with a wall thickness of the cladding elements 125, FM loss of light within the hollow core region 135 is minimized by satisfying an anti-resonant condition. Call-out 150 illustrates the respective thicknesses of some components described herein. For example, a cladding element 125 has a wall thickness 125a, which is a distance between an outer wall of the cladding element 125 and an inner wall of the cladding element 125. Similarly, a cladding element 130 has a wall thickness 130a, which is a distance between an outer wall of the cladding element 130 and an inner wall of the cladding element 130. The holding tube 115 has a holding tube thickness 115a, which is a distance between an outer wall of the holding tube 115 and an inner wall of the holding tube 115. As described in more details herein, the wall thickness 130a may satisfy an anti-resonant condition associated with reducing FM loss of light. Similarly, collective thickness 152, which is a sum of the wall thickness 125a and the holding tube wall thickness 115a, satisfies an anti-resonant condition associated with reducing FM loss of light.

An interior of the holding tube 115 may be, initially, a hollow volume into which the second set of cladding elements 130 are attached to define the inner cladding layer 120 and a hollow core region 135 therewithin. In some implementations, the hollow core region 135 or a gap between cladding elements 130 may be filled with air, another gas, or a vacuum, among other examples. In some implementations, the holding tube 115 may be manufactured from a material, such as a cladding material.

In some implementations, the second set of cladding elements 130 may define the hollow core region 135, which may be or may otherwise include a light guiding region and/or a light confinement region. For example, the first set of cladding elements 125 and the second set of cladding elements 130 may confine and guide light within the hollow core region 135. The hollow core region 135 may be associated with a negatively curved surface of the second set of cladding elements 130. In other words, although shown as a circular hollow core region 135, the hollow core region 135 follows the contours of the exterior walls of cladding elements 130 (e.g., a portion of the exterior wall that is facing inward toward a center of the circular hollow core region 135), which act as a boundary of the hollow core region 135. Gaps between the cladding elements 130 may form openings in the boundary of the hollow core region 135, which results in loss; however, as described herein, the presence of the first set of cladding elements 125, as an additional confinement layer, results in the openings in the boundary of the hollow core region 135 being closed (or being less open than occurs with single-layer HC-ARFs). Thus, the first set of cladding elements 125 and the second set of cladding elements 130 may be tubes that are configured to guide the light based on an anti-resonant effect that occurs as a result of a wall thickness 125a of the first set of cladding elements 125 combined with a holding tube thickness 115a of the holding tube 115 (e.g., the collective thickness 152) and an anti-resonant effect that occurs as a result of a wall thickness 130a of the second set of cladding elements 130.

In some implementations, the first set of cladding elements 125 and the second set of cladding elements 130 may be associated with a particular cross-section shape. For example, the first set of cladding elements 125 and the second set of cladding elements 130 may be configured with a circular cross-section to enhance an anti-resonant condition by which the first set of cladding elements 125 and the second set of cladding elements 130 guide light in the hollow core region 135 to reduce losses. In some implementations, the first set of cladding elements 125 and the second set of cladding elements 130 may be associated with a tube material, such as pure silica glass, that is different from a material of a cladding layer, such as the outer cladding layer 110, or the holding tube 115.

In some implementations, the first set of cladding elements 125 and the second set of cladding elements 130 may each be associated with a respective ring formation. For example, the first set of cladding elements 125 may be arranged in a first ring formation within the outer cladding layer 110, and the second set of cladding elements 125 may be arranged in a second ring formation within the inner cladding layer 120 (e.g., against the inner wall of the holding tube 115). In some implementations, the respective ring formations may be offset. For example, the first ring formation may be rotationally offset from the second ring formation, such that the first set of cladding elements 125 are aligned to gaps between adjacent cladding elements of the second set of cladding elements 130. In some implementations, one or more cladding elements 125 or 130 may be configured to convey a beam or an optical signal.

In some implementations, the cladding elements of the optical fiber 100 (e.g., the cladding elements 125 and 130) may be associated with a uniform distribution. For example, the first ring formation may include the first set of cladding elements 125 at 60 degree (°) offsets corresponding to the 12, 2, 4, 6, 8, and 10 o'clock positions, and the second ring formation may include the second set of cladding elements 130 at the 1, 3, 5, 7, 9, and 11 o'clock positions. Additionally, or alternatively, the cladding elements of the optical fiber 100 may be associated with a non-uniform distribution. For example, rather than having 6 cladding elements at 60° offsets, a layer of cladding elements, such as cladding elements 125, may have adjacent cladding elements at other offset angles. In this case, a first pair of cladding elements 125 or 130 may be offset by a first angular separation (e.g., 60°), but a second pair of cladding elements 125 or 130 may be offset by a second angular separation (e.g., 50° or another angle). In some implementations, each cladding element 125 and each cladding element 130 is associated with an offset angle sufficient to ensure that no cladding element is in contact with an adjacent cladding element. In other words, based on a size and quantity of cladding elements within a cladding layer, offset angles may be selected to ensure that there is a gap between adjacent cladding elements. Although it may be beneficial to have gaps between adjacent cladding elements, in some configurations one or more pairs of adjacent cladding elements may be touching, for example, as a result of manufacturing processes or to achieve a particular effect on the hollow core region 135 and light being guided therewithin.

In some implementations, a particular quantity of cladding elements may be provided in the optical fiber 100. For example, the outer cladding layer 110 may include a set of 6 cladding elements 125 and the inner cladding layer 120 may include a set of 6 cladding elements 130. Additionally, or alternatively, the outer cladding layer 110 and the inner cladding layer 120 may have other quantities of cladding elements, such as each cladding layer having 7, 8, 9, 10, or more cladding elements. In other configurations, fewer cladding elements may be included in a cladding layer. Additionally, or alternatively, the outer cladding layer 110 may have a different quantity of cladding elements than the inner cladding layer 120. For example, the inner cladding layer 120 may include a first quantity of cladding elements 130 and the outer cladding layer 110 may include a second (different) quantity of cladding elements 125.

In some implementations, a particular thickness of cladding elements may be provided in the optical fiber 100. For example, the outer cladding layer 110 may include a set of cladding elements 125 with a particular wall thickness and the inner cladding layer 120 may include a set of cladding elements 130 with the same particular wall thickness. The wall thicknesses are related to a wavelength being used, such as the particular wall thickness of the cladding elements 130 or the particular wall thickness of the cladding elements 125 combined with the holding tube wall thickness of the holding tube 115 being up to a few micrometers (e.g., approximately 2 micrometers) or on an order of several hundreds of nanometers (e.g., approximately 700 nanometers). In some implementations, the outer cladding layer 110 may have a different wall thickness of cladding elements than the inner cladding layer 120. For example, the inner cladding layer 120 may include a first wall thickness of cladding elements 130 and the outer cladding layer 110 may include a second (different) wall thickness of cladding elements 125. Additionally, or alternatively, different cladding elements within a cladding layer may have different wall thicknesses. For example, a first cladding element 125 may have a first wall thickness and a second cladding element 125 may have a second (different) wall thickness. In this case, by having different cladding element wall thicknesses within a single layer of cladding elements, the optical fiber 100 may cause birefringence, which may be used in some use cases, such as for polarization-maintaining fibers.

In some implementations, an anti-resonant condition of the optical fiber 100 and the hollow core region 135 thereof may be associated with a wall thickness of a cladding element 125 (e.g., combined with the holding tube 115) or the cladding element 130. For example, as described in more detail herein, wall thicknesses of the cladding elements 130 or 125 (e.g., combined with a holding tube wall thickness of the holding tube 115) may be configured to cause constructive interference between light that reflects from an outer wall border into a core and light that penetrates into the wall and then reflects from the inner wall border into the core. The wall thickness values for which light is reflected back to the hollow core region 135 as constructive interference may be referred to as “anti-resonant thicknesses.” The anti-resonant thickness may be approximated using an equation:

$$t = \frac{( m - 0.5 ) {λ}_{0}}{2 \sqrt{{n}_{1}^{2} - {n}_{0}^{2}}}$$

where t is the anti-resonant thickness, m is an order of a resonance band, λ is the wavelength of light that is to be constrained in the hollow core region 135, n₁ represents a refractive index of the cladding elements 125 or 130, and no represents a refractive index of the hollow core region 135 (e.g., a refractive index of air or another gas that fills the hollow core region 135). Accordingly, using such a numerical approximation, an anti-resonant thickness can be determined as an approximation or simulated numerically. For a multi-layer arrangement that includes cladding elements 125, cladding elements 130, and the holding tube 115 therebetween, the anti-resonant thickness may be the wall thickness of the cladding elements 130 or the sum of the wall thickness of the cladding elements 125 and the holding tube wall thickness of the holding tube 115, in some implementations. In one example, for a wavelength of 1030 nm, a thickness in a range of 0.73 micrometers (μm) to 0.79 μm may be selected as the anti-resonant thickness for the wavelength, which may result in a selection of wall thicknesses of 0.76 μm for the set of cladding elements 130, wall thicknesses of 0.38 μm for the set of cladding elements 125, and a holding tube wall thickness of 0.38 μm for the holding tube 115 (e.g., resulting in a thickness of 0.76 μm for the cladding elements 125 and the holding tube 115 together). Additionally, or alternatively, the wall thicknesses and arrangement of cladding elements 125 or 130 and the holding tube 115 may be selected to ensure that a fundamental mode has a smallest possible loss (e.g., amount of light that escapes from the hollow core region 135).

As indicated above, FIG. 1 is provided as an example. Other examples may differ from what is described with regard to FIG. 1.

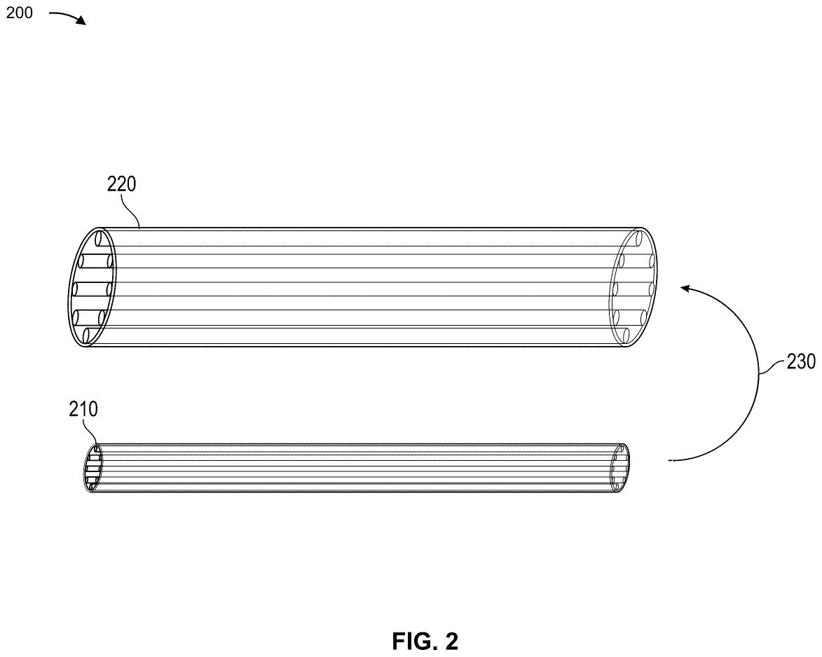

FIG. 2 is a diagram of an example implementation 200 of a stack, which is used in the production of and associated with an optical device, such as a multi-layer hollow-core anti-resonant optical fiber.

As shown in FIG. 2, the example implementation 200 may include a cane 210 that includes a set of inner cladding elements that are attached to a holding tube. The example implementation 200 may include a stack 220 that includes a set of outer cladding elements that are disposed within a cladding layer or an exterior cladding. As shown by reference number 230, the cane 210 may be disposed within the stack 220, such that the set of inner cladding elements form a hollow core and, together, the set of inner cladding elements and the set of outer cladding elements (in cooperation with the holding tube) provide anti-resonant conditions for the hollow core. Based on inserting the cane 210 into the stack 220, the cane 210 and stack 220 may be drawn together and inserted into a jacket tube to form an assembly. The assembly of the cane 210, the stack 220, and the jacket tube may be drawn into an optical fiber.

As indicated above, FIG. 2 is provided as an example. Other examples may differ from what is described with regard to FIG. 2.

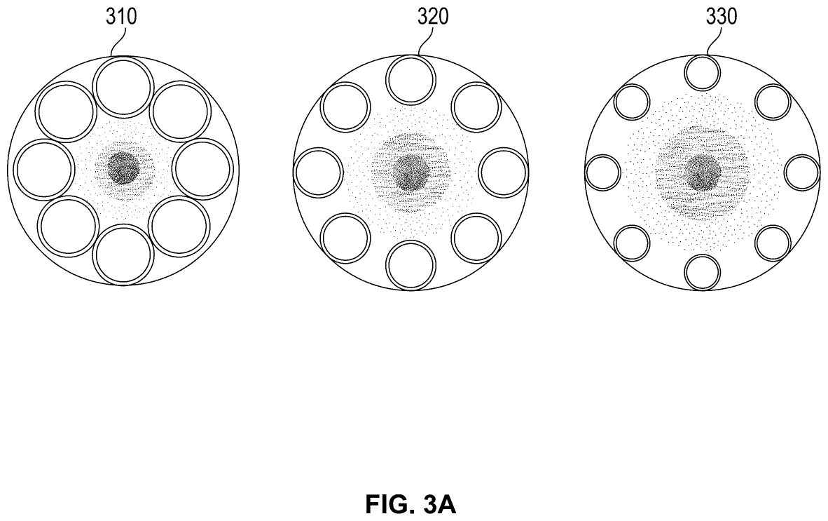

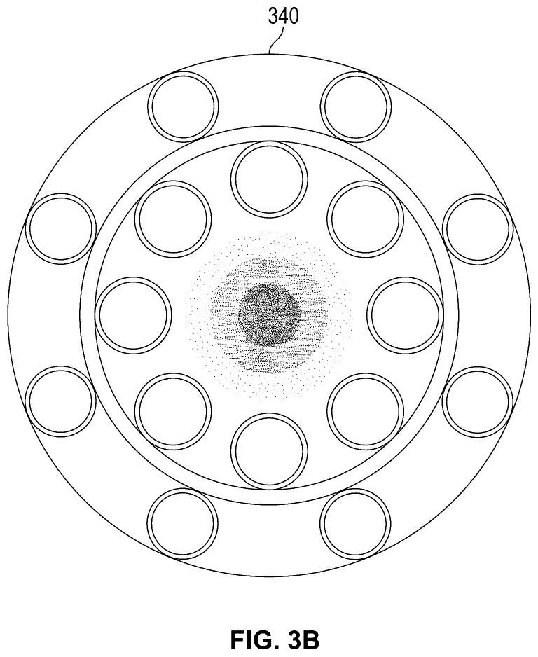

FIGS. 3A and 3B are diagrams of formation of a hollow core, such as for a hollow-core anti-resonant optical fiber.

As shown in FIG. 3A, in single-layer hollow-core anti-resonant optical fibers, different diameters of the single layer of cladding elements may result in different characteristics of a hollow core formed therein. For example, the first optical fiber 310 includes cladding elements with a first diameter, the second optical fiber 320 includes cladding elements with a second diameter, and the third optical fiber 330 includes cladding elements with a third diameter. The first diameter, which is the largest of the three diameters, causes the formation of junctions of glass (e.g., adjacent cladding elements are touching), which results in losses for the fundamental mode guided through the hollow core. In contrast, the third diameter, which is the smallest of the three diameters, allows for FM loss through excessively large gaps between the cladding elements. The second diameter represents an optimization between avoiding gaps for FM loss and avoiding the formation of junctions, thereby optimizing performance. However, as shown in FIG. 3B, by adding a second layer, for a multi-layer hollow-core anti-resonant optical fiber, performance may be further improved. For example, in FIG. 3B, the optical fiber 340 includes inner cladding elements with the second diameter and outer cladding elements with a fourth diameter aligned to gaps between the inner cladding elements. The inner cladding elements do not touch each other (e.g., junctions are not formed) and a presence of outer cladding elements provides additional anti-resonance which confines the fundamental mode, thereby achieving a reflection of light (in cooperation with the holding tube), which would otherwise escape between the inner cladding elements, back toward the core.

As indicated above, FIGS. 3A and 3B are provided as examples. Other examples may differ from what is described with regard to FIGS. 3A and 3B.

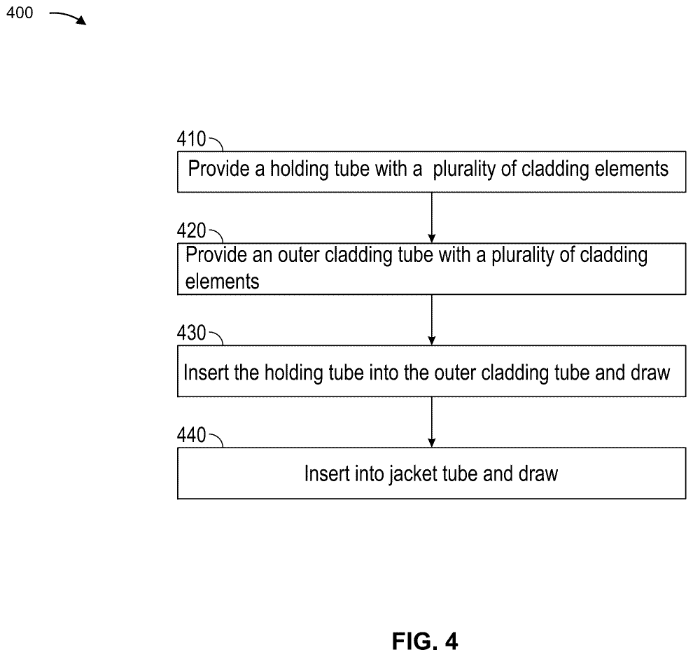

FIG. 4 is a flowchart of an example process 400 associated with manufacturing a multi-layer hollow-core anti-resonant optical fiber. One or more process blocks of FIG. 4 are performed by a manufacturing device.

As shown in FIG. 4, process 400 includes providing a holding tube with a plurality of cladding elements (block 410). For example, the manufacturing device may provide a holding tube with a first plurality of cladding elements formed therein, as described above. In some implementations, the manufacturing device may draw a set of capillary tubes and insert the set of capillary tubes into a holding tube. The manufacturing device may draw the holding tube and the set of capillary tubes into a cane 210. The manufacturing device may provide the cane 210 as the holding tube with the plurality of cladding elements.

As further shown in FIG. 4, process 400 includes providing an outer cladding tube with a plurality of cladding elements (block 420). For example, the manufacturing device may form the outer cladding tube with a second plurality of cladding elements formed therein, as described above. In some implementations, the manufacturing device may form a stack 220 that includes the second plurality of cladding elements on an exterior of the holding tube. The manufacturing device may provide the stack 220 as the outer cladding tube with the plurality of cladding elements.

As further shown in FIG. 4, process 400 includes inserting the holding tube into the outer cladding tube and drawing (block 430). For example, the manufacturing device may insert the cane 210, which includes a plurality of cladding elements formed therein, into an opening of the stack 220, which includes another plurality of cladding elements formed therein, thereby defining a hollow core for an optical fiber, as described above. In another words, the manufacturing device may insert a holding tube with a plurality of capillary elements into an outer cladding tube with a plurality of capillary elements to create two layers of capillary elements. In some implementations, the manufacturing device may draw the combined assembly.

As further shown in FIG. 4, process 400 includes inserting into a jacket tube and drawing (block 440). For example, the manufacturing device may insert the cane 210 and the stack 220 (e.g., formed from drawing the combined assembly of the holding tube, the outer cladding tube, the pluralities of cladding elements) into a jacket tube to form a combined assembly and may draw the combined assembly to form an optical fiber, as described above.

Process 400 may include additional aspects, such as any single aspect or any combination of aspects described herein and/or in connection with one or more other processes described elsewhere herein.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. An anti-resonant hollow-core optical fiber, comprising:
an outer cladding;
a holding tube;
a first plurality of cladding elements arranged within the outer cladding; and
a second plurality of cladding elements arranged in contact with an inner wall of the holding tube, such that the second plurality of cladding elements define a hollow core,
wherein a first wall thickness of the second plurality of cladding elements causes a first anti-resonant condition for the hollow core and a sum of a holding tube wall thickness and a wall thickness of first plurality of cladding elements causes a second anti-resonant condition for the hollow core.

2. The anti-resonant hollow-core optical fiber of claim 1, wherein cladding elements of the first plurality of cladding elements and the second plurality of cladding elements are separated by gaps, such that no cladding element is in contact with another cladding element.

3. The anti-resonant hollow-core optical fiber of claim 1, wherein the first plurality of cladding elements is rotationally offset from the second plurality of cladding elements, such that the first plurality of cladding elements is aligned to gaps between cladding elements of the second plurality of cladding elements.

4. The anti-resonant hollow-core optical fiber of claim 1, wherein the first anti-resonant condition and the second anti-resonant condition are associated with the respective wall thicknesses of the first plurality of cladding elements, the second plurality of cladding elements, and the holding tube being configured to reflect light, from the hollow core, back to the hollow core, such that there is constructive interference between light that reflects from an outer wall border into the core and light that penetrates into an outer wall and then reflects from an inner wall border into the core.

5. The anti-resonant hollow-core optical fiber of claim 1, wherein the first anti-resonant condition and the second anti-resonant condition are associated with a wavelength of light in the hollow core.

6. The anti-resonant hollow-core optical fiber of claim 1, wherein a first pair of cladding elements, of the second plurality of cladding elements, is associated with a first angular separation and a second pair of cladding elements, of the second plurality of cladding elements, is associated with a second angular separation.

7. An anti-resonant hollow-core optical fiber, comprising:
an exterior cladding;
a first layer disposed within the exterior cladding and defining a first inner volume,
wherein the first layer includes a first set of cladding elements;
a second layer disposed within the first layer and defining a second inner volume,
wherein the second layer includes a second set of cladding elements,
wherein the second set of cladding elements defines a hollow core; and
a holding tube disposed between the first layer and the second layer,
wherein a configuration of the first set of cladding elements, the second set of cladding elements, and the holding tube is associated with reducing a loss of a fundamental mode associated with the hollow core.

8. The anti-resonant hollow-core optical fiber of claim 7, wherein the first set of cladding elements is associated with a first ring formation and the second set of cladding elements is associated with a second ring formation.

9. The anti-resonant hollow-core optical fiber of claim 8, wherein the first ring formation and the second ring formation are configured with gaps between cladding elements, such that no cladding element, of the first set of cladding elements or the second set of cladding elements, is in contact with any other cladding element of the first set of cladding elements or the second set of cladding elements.

10. The anti-resonant hollow-core optical fiber of claim 8, wherein the first ring formation is offset from the second ring formation, such that the first set of cladding elements is aligned to gaps between the second set of cladding elements.

11. The anti-resonant hollow-core optical fiber of claim 7, wherein a first cladding element of the second set of cladding elements is associated with a first thickness and a second cladding element of the second set of cladding elements is associated with a second thickness, such that a birefringent condition is configured with respect to the hollow core.

12. The anti-resonant hollow-core optical fiber of claim 7, wherein the first set of cladding elements includes two or more cladding elements.

13. The anti-resonant hollow-core optical fiber of claim 7, wherein the second set of cladding elements includes two or more cladding elements.

14. The anti-resonant hollow-core optical fiber of claim 7, wherein a simulated confinement loss of the fundamental mode is less than 1 decibel (dB) per kilometer (km).

15. The anti-resonant hollow-core optical fiber of claim 7, wherein the exterior cladding is a jacket tube.

16. A layered hollow-core optical fiber, comprising:
a first plurality of cladding elements disposed in a first interior volume;
a second plurality of cladding elements disposed in a second interior volume; and
a holding tube disposed between the first interior volume and the second interior volume,
wherein the second plurality of cladding elements define a hollow core, and
wherein respective wall thicknesses of the first plurality of cladding elements, the second plurality of cladding elements, and the holding tube are configured to cause an anti-resonant condition for the hollow core.

17. The layered hollow-core optical fiber of claim 16, comprising:
an exterior cladding surrounding the first plurality of cladding elements.

18. The layered hollow-core optical fiber of claim 16, comprising:
a fill material disposed between first cladding elements of the first plurality of cladding elements or second cladding elements of the second plurality of cladding elements.

19. The layered hollow-core optical fiber of claim 16, wherein adjacent cladding elements of the first plurality of cladding elements and the second plurality of cladding elements do not touch.

20. The layered hollow-core optical fiber of claim 16, wherein the anti-resonant condition is associated with a wavelength of light in the hollow core.
